(19) United States
(12) Patent Application Publication
(10) Pub. No.: US 2022/0237048 A1
(43) Pub. Date: Jul. 28, 2022

(54) AFFINITY AND ANTI-AFFINITY FOR SETS OF RESOURCES AND SETS OF DOMAINS IN A VIRTUALIZED AND CLUSTERED COMPUTER SYSTEM

(71) Applicant: VMware, Inc., Palo Alto, CA (US)

(72) Inventor: Maarten WIGGERS, San Francisco, CA (US)

(21) Appl. No.: 17/159,073

(22) Filed: Jan. 26, 2021

(51) Int. Cl. G06F 9/50; G06F 9/455

(52) U.S. Cl. CPC G06F 9/5077; G06F 2209/505; G06F 2209/5011; G06F 9/45541

(57) ABSTRACT

An example method of placing resources in domains in a virtualized computing system is described. A host cluster includes a virtualization layer executing on hardware platforms of the hosts. The method includes: determining, at a virtualization management server, definitions of the domains and resource groups, each of the domains including a plurality of placement targets, each of the resource groups including a plurality of the resources; receiving, at the virtualization management server from the user, affinity/anti-affinity rules that control placement of the resource groups within the domains; and placing, by the virtualization management server, the resource groups within the domains based on the affinity/anti-affinity rules.

Applications today are deployed onto a combination of virtual machines (VMs), containers, application services, and more within a software-defined datacenter (SDDC). The SDDC includes a server virtualization layer having clusters of physical servers that are virtualized and managed by virtualization management servers. A virtual infrastructure administrator (“VI admin”) interacts with a virtualization management server to create server clusters (“host clusters”), add/remove servers (“hosts”) from host clusters, deploy/move/remove VMs on the hosts, deploy/configure networking and storage virtualized infrastructure, and the like. Each host includes a virtualization layer (e.g., a hypervisor) that provides a software abstraction of a physical server (e.g., central processing unit (CPU), random access memory (RAM), storage, network interface card (NIC), etc.) to the VMs. The virtualization management server sits on top of the server virtualization layer of the SDDC and treats host clusters as pools of compute capacity for use by applications.

In addition, for deploying such applications, a container orchestrator (CO) known as Kubernetes® has gained in popularity among application developers. Kubernetes provides a platform for automating deployment, scaling, and operations of application containers across clusters of hosts. It offers flexibility in application development and offers several useful tools for scaling. In a Kubernetes system, containers are grouped into logical units called “pods” that execute on nodes in a duster (also referred to as “node cluster”) Containers in the same pod share the same resources and network and maintain a degree of isolation from containers in other pods. The pods are distributed across nodes of the cluster.

In an SDDC, a user can specify affinity and/or anti-affinity rules for VMs with respect to their placement in hosts of the host cluster. Both the VI control plane and the Kubernetes control plane allows for defining affinity/anti-affinity rules on a per VM basis. However, some VMs can be related in some way such that a user desires to treat them as a group of VMs. As more and more groups of VMs are deployed, defining and maintaining per-VM affinity/anti-affinity rules becomes complex and can result in inefficient use of hosts in the host cluster.

### SUMMARY

In an embodiment, a method of placing resources in domains of a virtualized computing system is described. A host cluster includes a virtualization layer executing on hardware platforms of the hosts. The method includes: determining, at a virtualization management server, definitions of the domains and resource groups, each of the domains including a plurality of placement targets, each of the resource groups including a plurality of the resources; receiving, at the virtualization management server from the user, affinity/anti-affinity rules that control placement of the resource groups within the domains; and placing, by the virtualization management server, the resource groups within the domains based on the affinity/anti-affinity rules.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a clustered computer system in which embodiments may be implemented.

FIG. 2 is a block diagram depicting a software platform according an embodiment.

FIG. 3 is a block diagram of a supervisor Kuhernetes master according to an embodiment.

FIG. 4 is a flow diagram depicting a method of placing VMs in a host cluster based on affinity/anti-affinity to host domains according to an embodiment.

FIG. 5 is a block diagram depicting a placement of VMs in hosts based on affinity/anti-affinity rules according to an embodiment.

FIG. 6 is a flow diagram depicting a method of placing Vis in a host cluster based on affinity/anti-affinity to host domains and constraints according to an embodiment.

### DETAILED DESCRIPTION

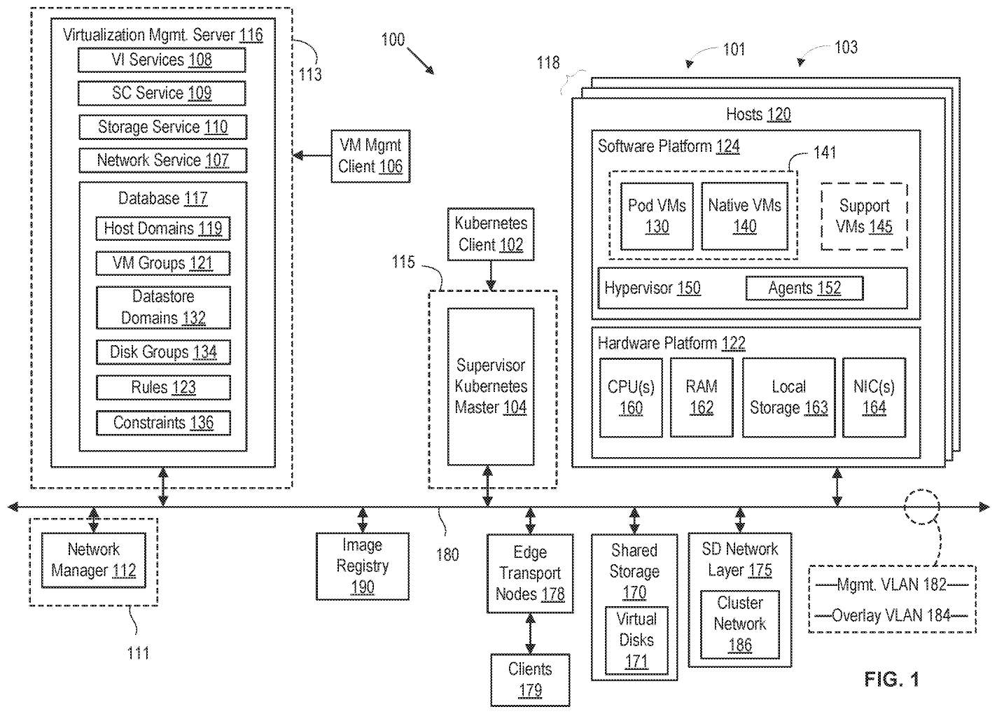

FIG. 1 is a block diagram of a virtualized computing system 100 in which embodiments described herein may be implemented. System 100 includes a cluster of hosts 120 (“host cluster 118”) that may be constructed on server-grade hardware platforms such as an x86 architecture platforms. Note that cluster as used herein can be a group of hosts managed by a virtualization management server or multiple groups of hosts managed by multiple virtualization management servers (e.g., a virtual datacenter, sets of virtual datacenters, etc.). For purposes of clarity by example, a single virtualization management server is shown. For purposes of clarity, only one host cluster 118 is shown. However, virtualized computing system 100 can include many of such host clusters 118. As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 180. Physical network 180 enables communication between hosts 120 and between other components and hosts 120 (other components discussed further herein). Physical network 180 can include a plurality of VLANs to provide external network virtualization as described further herein.

In the embodiment illustrated in FIG. 1, hosts 120 access shared storage 170 by using NICs 164 to connect to network 180. In another embodiment, each host 120 contains a host bus adapter (HBA) through which input/output operations (IOs) are sent to shared storage 170 over a separate network (e.g., a fibre channel (FC) network). Shared storage 170 include one or more storage arrays, such as a storage area network (SAN), network attached storage (NAS), or the like, Shared storage 170 may comprise tape, magnetic disks, solid-state disks, flash memory, and the like as well as combinations thereof in some embodiments, hosts 120 include local storage 163 (e.g., hard disk drives, solid-state drives, etc.). Local storage 163 in each host 120 can be aggregated and provisioned as part of a virtual SAN, which is another form of shared storage 170. Shared storage 170 can store virtual disks 171, which can be attached to the VMs in host cluster 118.

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122, Thus, hypervisor 150 is a Type-1 hypervisor (also known as a “bare-metal” hypervisor). As a result, the virtualization layer in host cluster 118 (collectively hypervisors 150) is a bare-metal virtualization layer executing directly on host hardware platforms. Hyper-visor 150 abstracts processor, memory, storage, and network resources of hardware platform 122 to provide a virtual machine execution space within which multiple virtual machines (VM) may be concurrently instantiated and executed. One example of hypervisor 150 that may be configured and used in embodiments described herein is a VMware LSXi™ hypervisor provided as part of the VMware vSphere® solution made commercially available by VMware, Inc. of Palo Alto, Calif.

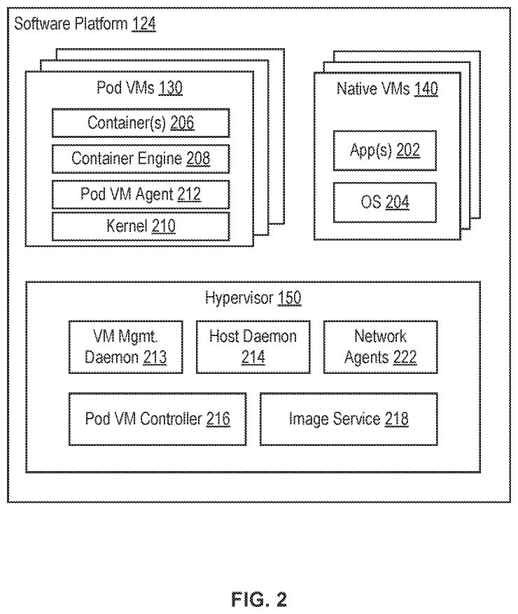

In the example of FIG. 1, host cluster 118 can be enabled as a “supervisor cluster,” described further herein, and thus VMs executing on each host 120 include pod VMs 130 and native VMs 140. A pod VM 130 is a virtual machine that includes a kernel and container engine that supports execution of containers, as well as an agent (referred to as a pod VM agent) that cooperates with a controller of an orchestration control plane 115 executing in hypervisor 150 (referred to as a pod VM controller). An example of pod VM 130 is described further below with respect to FIG. 2. VMs 130/140 support applications 141 deployed onto host cluster 118, which can include containerized applications (e.g., executing in either pod VMs 130 or native VMs 140) and applications executing directly on guest operating systems (non-containerized) (e.g., executing in native VMs 140). One specific application discussed further herein is a guest cluster executing as a virtual extension of a supervisor cluster. Some VMs 130/140, shown as support VMs 145, have specific functions within host cluster 118. For example, support VMs 145 can provide control plane functions, edge transport functions, and the like. An embodiment of software platform 124 is discussed further below with respect to FIG. 2.

Host cluster 118 is configured with a software-defined (SD) network layer 175. SD network layer 175 includes logical network services executing on virtualized infrastructure in host cluster 118. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches, logical routers, logical firewalls, logical virtual private networks (VPNs), logical load balancers, and the like, implemented on top of the virtualized infrastructure. In embodiments, virtualized computing system 100 includes edge transport nodes 178 that provide an interface of host cluster 118 to an external network (e.g., a corporate network, the public Internet, etc.). Edge transport nodes 178 can include a gateway between the internal logical networking of host cluster 118 and the external network. Edge transport nodes 178 can be physical servers or VMs. For example, edge transport nodes 178 can be implemented in support VMs 145 and include a gateway of SD network layer 175. Various clients 179 can access service(s) in virtualized computing system through edge transport nodes 178 (including VM management client 106 and Kubernetes client 102, which as logically shown as being separate by way of example).

Virtualization management server 116 is a physical or virtual server that manages host cluster 118 and the virtualization layer therein. Virtualization management server 116 installs agent(s) 152 in hypervisor 150 to add a host 120 as a managed entity. Virtualization management server 116 manages hosts 120 as a host cluster 118 to provide cluster-level functions to hosts 120, such as VM migration between hosts 120 (e.g., for load balancing), distributed power management, dynamic VM placement, and high-availability. The number of hosts 120 in host cluster 118 may be one or many. Virtualization management server 116 can manage more than one host cluster 118.

In an embodiment, virtualization management server 116 further enables host cluster 118 as a supervisor cluster 101. Virtualization management server 116 installs additional agents 152 in hypervisor 150 to add host 120 to supervisor cluster 101. Supervisor cluster 101 integrates an orchestration control plane 115 with host cluster 118. In embodiments, orchestration control plane 115 includes software components that support a container orchestrator, such as Kubernetes, to deploy and manage applications on host cluster 118. By way of example, a Kubernetes container orchestrator is described herein. In supervisor cluster 101, hosts 120 become nodes of a Kubernetes cluster and pod VMs 130 executing on hosts 120 implement Kubernetes pods. Orchestration control plane 115 includes supervisor Kubernetes master 104 and agents 152 executing in virtualization layer (e.g., hypervisors 150). Supervisor Kubernetes master 104 includes control plane components of Kubernetes, as well as custom controllers, custom plugins, scheduler extender, and the like that extend Kubernetes to interface with virtualization management server 116 and the virtualization layer. For purposes of clarity, supervisor Kubernetes master 104 is shown as a separate logical entity. For practical implementations, supervisor Kubernetes master 104 is implemented as one or more VM(s) 130/140 in host cluster 118. Further, although only one supervisor Kubernetes master 104 is shown, supervisor cluster 101 can include more than one supervisor Kubernetes master 104 in a logical cluster for redundancy and load balancing. Virtualized computing system 100 can include one or more supervisor Kubernetes masters 104 (also referred to as “master server(s)”).

In an embodiment, virtualized computing system 100 further includes a storage service 110 that implements a storage provider in virtualized computing system 100 for container orchestrators. In embodiments, storage service 110 manages lifecycles of storage volumes (e.g., virtual disks) that back persistent volumes used by containerized applications executing in host cluster 118. A container orchestrator such as Kubernetes cooperates with storage service 110 to provide persistent storage for the deployed applications. In the embodiment of FIG. 1, supervisor Kubernetes master 104 cooperates with storage service 110 to deploy and manage persistent storage in the supervisor cluster environment. Other embodiments described below include a vanilla container orchestrator environment and a guest cluster environment. Storage service 110 can execute in virtualization management server 116 as shown or operate independently from virtualization management server 116 (e.g., as an independent physical or virtual server).

In an embodiment, virtualized computing system 100 further includes a network manager 112. Network manager 112 is a physical or virtual server that orchestrates SD network layer 175. In an embodiment, network manager 112 comprises one or more virtual servers deployed as VMs. Network manager 112 installs additional agents 152 in hypervisor 150 to add a host 120 as a managed entity, referred to as a transport node. In this manner, host cluster 118 can be a cluster 103 of transport nodes. One example of an SD networking platform that can be configured and used in embodiments described herein as network manager 112 and SD network layer 175 is a VMware NSX® platform made commercially available by VMware, Inc. of Palo Alto, Calif.

Network manager 112 can deploy one or more transport zones in virtualized computing system 100, including VLAN transport zone(s) and an overlay transport zone. A VLAN transport zone spans a set of hosts 120 (e.g., host cluster 118) and is backed by external network virtualization of physical network 180 (e.g., a VLAN). One example VLAN transport zone uses a management VLAN 182 on physical network 180 that enables a management network connecting hosts 120 and the VI control plane (e.g., virtualization management server 116 and network manager 112). An overlay transport zone using overlay VLAN 184 on physical network 180 enables an overlay network that spans a set of hosts 120 (e.g., host cluster 118) and provides internal network virtualization using software components (e.g., the virtualization layer and services executing in VMs). Host-to-host traffic for the overlay transport zone is carried by physical network 180 on the overlay VI AN 184 using layer-2-over-layer-3 tunnels. Network manager 112 can configure SD network layer 175 to provide a cluster network 186 using the overlay network. The overlay transport zone can be extended into at least one of edge transport nodes 178 to provide ingress/egress between cluster network 186 and an external network.

In an embodiment, system 100 further includes an image registry 190. As described herein, containers of supervisor cluster 101 execute in pod VMs 130. The containers in pod VMs 130 are spun up from container images managed by image registry 190. Image registry 190 manages images and image repositories for use in supplying images for containerized applications.

Virtualization management server 116 implements a virtual infrastructure (VI) control plane 113 of virtualized computing system 100. VI control plane 113 controls aspects of the virtualization layer for host cluster 118 (e.g., hypervisor 150). Network manager 112 implements a network control plane 111 of virtualized computing system 100. Network control plane 111 controls aspects SD network layer 175.

Virtualization management server 116 can include a supervisor cluster service 109 (“SC service 109”), storage service 110, network service 107, protection service(s) 105, and VI services 108. Supervisor cluster service 109 enables host cluster 118 as supervisor cluster 101 and deploys the components of orchestration control plane 115. VI services 108 include various virtualization management services, such as a distributed resource scheduler (DRS), high-availability (HA) service, single sign-on (SSO) service, virtualization management daemon, and the like. DRS is configured to aggregate the resources of host cluster 118 to provide resource pools and enforce resource allocation policies. DRS also provides resource management in the form of load balancing, power management, VM placement, and the like. HA service is configured to pool VMs and hosts into a monitored cluster and, in the event of a failure, restart VMs on alternate hosts in the cluster. A single host is elected as a master, which communicates with the HA service and monitors the state of protected VMs on subordinate hosts. The HA service uses admission control to ensure enough resources are reserved in the cluster for VM recovery when a host fails. SSO service comprises security token service, administration server, director service, identity management service, and the like configured to implement an 550 platform for authenticating users. The virtualization management daemon is configured to manage objects, such as data centers, clusters, hosts, VMs, resource pools, datastores, and the like. Network service 107 is configured to interface an API of network manager 112. Virtualization management server 108 communicates with network manager 112 through network service 107.

A VI admin can interact with virtualization management server 116 through a VM management client 106. Through VM management client 106, a VI admin commands virtualization management server 116 to form host cluster 118, configure resource pools, resource allocation policies, and other cluster-level functions, configure storage and networking, enable supervisor cluster 101, deploy and manage image registry 190, and the like.

Kuhernetes client 102 represents an input interface for a user to supervisor Kubernetes master 104. Kubernetes client 102 is commonly referred to as kubectl. Through Kuhernetes client 102, a user submits desired states of the Kubernetes system, e.g., as YAML documents, to supervisor Kubernetes master 104. In embodiments, the user submits the desired states within the scope of a supervisor namespace. A “supervisor namespace” is a shared abstraction between VI control plane 113 and orchestration control plane 115. Each supervisor namespace provides resource-constrained and authorization-constrained units of multi-tenancy, A supervisor namespace provides resource constraints, user-access constraints, and policies (e.g., storage policies, network policies, etc.). Resource constraints can be expressed as quotas, limits, and the like with respect to compute (CPU and memory), storage, and networking of the virtualized infrastructure (host cluster 118, shared storage 170, SD network layer 175). User-access constraints include definitions of users, roles, permissions, bindings of roles to users, and the like. Each supervisor namespace is expressed within orchestration control plane 115 using a namespace native to orchestration control plane 115 (e.g., a Kubernetes namespace or generally a “native namespace”), which allows users to deploy applications in supervisor cluster 101 within the scope of supervisor namespaces. In this manner, the user interacts with supervisor Kubernetes master 104 to deploy applications in supervisor cluster 101 within defined supervisor namespaces.

While FIG. 1 shows an example of a supervisor cluster 101, the techniques described herein do not require a supervisor duster 101. In some embodiments, host duster 118 is not enabled as a supervisor cluster 101. In such case, supervisor Kubernetes master 104, Kubernetes client 102, pod VMs 130, supervisor cluster service 109, and image registry 190 can be omitted. While host cluster 118 is show as being enabled as a transport node cluster 103, in other embodiments network manager 112 can be omitted. In such case, virtualization management server 116 functions to configure SD network layer 175.

In an embodiment, virtualization management server 116 determines domains. Each domain includes a plurality of placement targets for resources, such as VMs, virtual disks, and the like. For example, placement targets can include hosts (as placement targets for VMs) or datastores (as placement targets for virtual disks 171). In an embodiment, domains can be explicit domains. For example, a user interacts with virtualized computing system 100 to define domains of hosts (“host domains 119”). A host domain 119 includes multiple hosts associated by a user. For example, a user can form host domains based on racks of hosts, where each rack is a host domain. In embodiments, host domains 119 can be hierarchical. For example, a user can group hosts into host domains for racks, host domains for zones, and host domains for regions. Each zone includes multiple racks, and each region includes multiple zones. In embodiments, within a level of the hierarchy (e.g., racks), host domains 119 do not overlap (e.g., any one host is not present in more than one host domain). There is overlap between levels of a hierarchy (e.g., a host can be in host domain for a rack, a host domain for a zone, and a host domain for a region). In embodiments, a single host can be part of multiple such hierarchies. For example, in addition to location-based hierarchy described above, there can be a power hierarchy and/or a network hierarchy. For example, some set of racks are in the same row in a datacenter and dependent on the same power-line that runs across those racks. Similarly sets of hosts can depend on a particular router or firewall or other piece of network equipment. In similar fashion to host domains 119, a user can define datastore domains 132, which are domains of datastores managed by virtualization management server 116.

In an embodiment, domains can be implicit domains, which virtualization management server 116 can create in relation to configured behavior by the user. One example of an implicit domain is that a host-specific affinity rule can refer to a VM tag, Because this behavior only applies within a single cluster, what this means is that a cluster scheduler in VI services 108 creates a list of VMs within the cluster with this tag and keeps this list up-to-date. Another example implicit group is created base on a constraint that a set of VMs can only be placed on three hosts, which is provided a cluster scheduler in VI services 108. The cluster scheduler can pick three hosts and report back which hosts it picked. The user is not actually involved in the construction of the host domain except for the two constraints: (1) in which cluster the hosts should be, and (2) how many hosts should maximally be in this host domain. Thus, domains can be either explicit domains or implicit domains.

In an embodiment, virtualization management server determines resource groups. Each resource group includes a plurality of resources, such as VMs, virtual disks, or the like. In an embodiment, resource groups can be explicit resource groups. For example, a user interacts with virtualized computing system 100 to define groups of VMs (“VM groups 121”). Each VM group 121 includes a plurality of VMs 130/140/145. A user also specifies affinity/anti-affinity rules 123. The term “affinity/anti-affinity rules” encompasses both affinity rules and anti-affinity rules. Affinity/anti-affinity rules 123 can be defined within a VM group 121 so that a VM group 121 becomes either an affinity VM group or an anti-affinity VM group. An affinity VM group dictates that the VMs therein are to be placed in the same host domain 119. An anti-affinity VM group dictates that the VMs therein are to be placed in different host domains 119. That is, if an anti-affinity VM group includes three VMs, then the three VMs are placed across three different host domains 119. Affinity/anti-affinity rules 123 can also be defined between VM groups 121. For example, a user can define an affinity rule 123 that dictates two VM groups 121 to be placed in the same host domain 119. In another example, a user can define an anti-affinity rule 123 that dictates two VM groups 121 be placed in two different host domains 119. A given VM group 121 can have multiple rules 123 attached thereto. For example, a VM group 121 can have an affinity rule for the VMs therein (an intra-affinity rule) and an anti-affinity rule with another VM group. Virtualization management server 116 can also create implicit resource groups, similar to creation of implicit domains described above. In similar fashion to VM groups 121, a user can define disk groups 134, which are groups of virtual disks 171.

In an embodiment, a user can define host domains 119, datastore domains 132, VM groups 121, disk groups 134, and rules 123 through interaction with virtualization management server 116 using VM management client 106 or the like. Virtualization management server 116 can include a database 117, managed by VI services 108, that stores information defining host domains 119, datastore domains 132, VM groups 121, disk groups 134, and rules 123. In an embodiment, a user can define some of resource groups and/or rules 123 through interaction with supervisor Kubernetes master 104 using Kubernetes client 102 (e.g., for pod VMs 130 and/or native VMs 140 under management). Supervisor Kubernetes master 104 can pass the information to virtualization management server 116, which generates the resource groups and/or rules 123 in database 117.

In an embodiment, virtualization management server 116 expresses domains and resource groups using tags. For example, virtualization management server 116, through VI services 108, manages hosts, VMs, virtual disks, and datastores, information for which is maintained in database 117. Virtualization management server 116 can tag a placement target with a particular tag that indicates membership in a domain. Virtualization management server 116 can tag a resource with a particular tag that indicates membership in a domain.

FIG. 2 is a block diagram depicting software platform 124 according an embodiment. As described above, software platform 124 of host 120 includes hypervisor 150 that supports execution of VMs, such as pod VMs 130, native VMs 140, and support VMs 145. In an embodiment, hypervisor 150 includes a VM management daemon 213, a host daemon 214, a pod VM controller 216, an image service 218, and network agents 222. VM management daemon 213 is an agent 152 installed by virtualization management server 116, VM management daemon 213 provides an interface to host daemon 214 for virtualization management server 116. Host daemon 214 is configured to create, configure, and remove VMs (e.g., pod VMs 130 and native VMs 140).

Pod VM controller 216 is an agent 152 of orchestration control plane 115 for supervisor cluster 101 and allows supervisor Kubernetes master 104 to interact with hypervisor 150. Pod VM controller 216 configures the respective host as a node in supervisor cluster 101. Pod VM controller 216 manages the lifecycle of pod VMs 130, such as determining when to spin-up or delete a pod VM. Pod VM controller 216 also ensures that any pod dependencies, such as container images, networks, and volumes are available and correctly configured. Pod VM controller 216 is omitted if host cluster 118 is not enabled as a supervisor cluster 101, Pod VM controller 216 can execute as a process within hypervisor 150. However, in an embodiment, pod VM controller 216 executes in a VM, such as a pod VM 130 or a native VM 140.

Image service 218 is configured to pull container images from image registry 190 and store them in shared storage 170 such that the container images can be mounted by pod VMs 130. Image service 218 is also responsible for managing the storage available for container images within shared storage 170. This includes managing authentication with image registry 190, assuring providence of container images by verifying signatures, updating container images when necessary, and garbage collecting unused container images. Image service 218 communicates with pod VM controller 216 during spin-up and configuration of pod VMs 130. In some embodiments, linage service 218 is part of pod VM controller 216. In embodiments, image service 218 utilizes system VMs 130/140 in support VMs 145 to fetch images, convert images to container image virtual disks, and cache container image virtual disks in shared storage 170.

Network agents 222 comprises agents 152 installed by network manager 112. Network agents 222 are configured to cooperate with network manager 112 to implement logical network services. Network agents 222 configure the respective host as a transport node in a cluster 103 of transport nodes.

Each pod VM 130 has one or more containers 206 running therein in an execution space managed by container engine 208. The lifecycle of containers 206 is managed by pod VM agent 212. Both container engine 208 and pod VM agent 212 execute on top of a kernel 210 (e.g., a Linux® kernel). Each native VM 140 has applications 202 running therein on top of an OS 204. Native VMs 140 do not include pod VM agents and are isolated from pod VM controller 216. Container engine 208 can be an industry-standard container engine, such as libcontainer, rune, or container. Pod VMs 130, pod VM controller 216, and image service 218 are omitted if host cluster 118 is not enabled as a supervisor cluster 101.

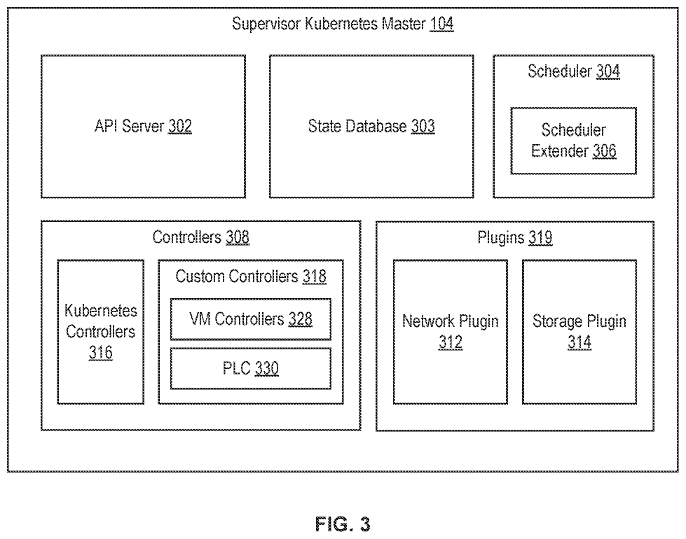

FIG. 3 is a block diagram of supervisor Kubernetes master 104 according to an embodiment. Supervisor Kubernetes master 104 includes application programming interface (API) server 302, a state database 303, a scheduler 304, a scheduler extender 306, controllers 308, and plugins 319. API server 302 includes the Kubernetes API server, kube-api-server (“Kubernetes API”) and custom APIs. Custom APIs are API extensions of Kubernetes API using either the custom resource/operator extension pattern or the API extension server pattern. Custom APIs are used to create and manage custom resources, such as VM objects for native VMs, API server 302 provides a declarative schema for creating, updating, deleting, and viewing objects.

State database 303 stores the state of supervisor cluster 101 (e.g., etcd) as objects created by API server 302. A user can provide application specification data to API server 302 that defines various objects supported by the API (e.g., as YAML document). The objects have specifications that represent the desired state. State database 303 stores the Objects defined by application specification data as part of the supervisor cluster state. Standard Kubernetes objects (“Kubernetes objects”) include namespaces, nodes, pods, config maps, secrets, among others. Custom objects are resources defined through custom APIs (e.g., VM objects).

Namespaces provide scope for objects. Namespaces are objects themselves maintained in state database 303. A namespace can include resource quotas, limit ranges, role bindings, and the like that are applied to objects declared within its scope. VI control plane 113 creates and manages supervisor namespaces for supervisor cluster 101. A supervisor namespace is a resource-constrained and authorization-constrained unit of multi-tenancy managed by virtualization management server 116. Namespaces inherit constraints from corresponding supervisor cluster namespaces. Config maps include configuration information for applications managed by supervisor Kubernetes master 104. Secrets include sensitive information for use by applications managed by supervisor Kubernetes master 104 (e.g., passwords, keys, tokens, etc.). The configuration information and the secret information stored by config maps and secrets is generally referred to herein as decoupled information. Decoupled information is information needed by the managed applications, but which is decoupled from the application code.

Controllers 308 can include, for example, standard Kubernetes controllers (“Kubernetes controllers 316”) (e.g., kube-controller-manager controllers, cloud-controller-manager controllers, etc.) and custom controllers 318. Custom controllers 318 include controllers for managing lifecycle of Kubernetes objects 310 and custom objects. For example, custom controllers 318 can include a VM controllers 328 configured to manage VM objects and a pod VM lifecycle controller (PLC) 330 configured to manage pods. A controller 308 tracks objects in state database 303 of at least one resource type. Controller(s) 318 are responsible for making the current state of supervisor cluster 101 come closer to the desired state as stored in state database 303. A controller 318 can carry out action(s) by itself, send messages to API server 302 to have side effects, and/or interact with external systems.

Plugins 319 can include, for example, network plugin 312 and storage plugin 314. Plugins 319 provide a well-defined interface to replace a set of functionality of the Kubernetes control plane. Network plugin 312 is responsible for configuration of SD network layer 175 to deploy and configure the cluster network. Network plugin 312 cooperates with virtualization management server 116 and/or network manager 112 to deploy logical network services of the cluster network. Network plugin 312 also monitors state database for custom objects 307, such as IF objects. Storage plugin 314 is responsible for providing a standardized interface for persistent storage lifecycle and management to satisfy the needs of resources requiring persistent storage. Storage plugin 314 cooperates with virtualization management server 116 and/or persistent storage manager 110 to implement the appropriate persistent storage volumes in shared storage 170.

Scheduler 304 watches state database 303 for newly created pods with no assigned node. A pod is an object supported by API server 302 that is a group of one or more containers, with network and storage, and a specification on how to execute. Scheduler 304 selects candidate nodes in supervisor cluster 101 for pods. Scheduler 304 cooperates with scheduler extender 306, which interfaces with virtualization management server 116. Scheduler extender 306 cooperates with virtualization management server 116 (e.g., such as with DRS) to select nodes from candidate sets of nodes and provide identities of hosts 120 corresponding to the selected nodes. For each pod, scheduler 304 also converts the pod specification to a pod VM specification, and scheduler extender 306 asks virtualization management server 116 to reserve a pod VM on the selected host 120. Scheduler 304 updates pods in state database 303 with host identifiers.

Kubernetes API 326, state database 303, scheduler 304, and Kubernetes controllers 316 comprise standard components of a Kubernetes system executing on supervisor cluster 101. Custom controllers 318, plugins 319, and scheduler extender 306 comprise custom components of orchestration control plane 115 that integrate the Kubernetes system with host cluster 118 and VI control plane 113.

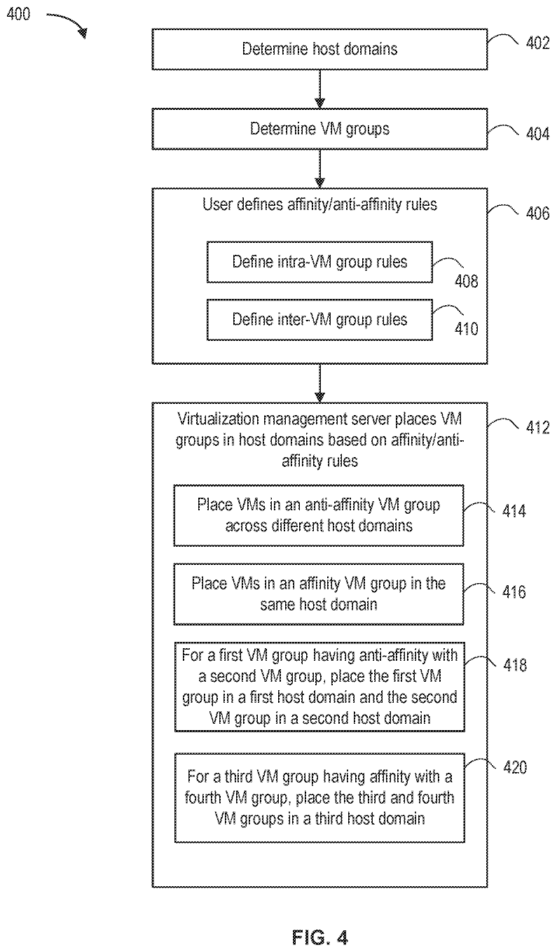

FIG. 4 is a flow diagram depicting a method 400 of placing VMs in host cluster 118 based on affinity/anti-affinity to host domains according to an embodiment. In method 400, the resources are VMs, the resource groups are VM groups, and the domains are host domains each having a plurality of hosts 120. It is to be understood that method 400 can be similarly performed for different resources, resource groups, and domains. For example, the resources can be virtual disks, the resource groups disk groups, and the domains datastore domains each having a plurality of datastores. For purposes of clarity by example, method 400 is described with respect to VMs, VM groups, and host domains, but is applicable to resources, resource groups, and domains more generally.

Method 400 begins at step 402, where virtualization management server 116 determines host domains 119. In an embodiment, the user interacts with virtualization management server 116 to define host domains 119. In another embodiment, virtualization management server 116 determines host domains 119 implicitly. As discussed above, each host domain 119 includes a group of hosts 120 and can include one or more levels of a hierarchy. At step 404, virtualization management server 116 determines VM groups 121. In an embodiment, the user interacts with virtualization management server 116 to define VM groups 121. In another embodiment, a user interacts with supervisor Kubernetes master 104 to define VM groups 121 (assuming supervisor cluster 101 is enabled). In another embodiment, virtualization management server 116 creates VM groups 121 explicitly. As discussed above, each VM group includes a plurality of VMs, which can include pod VMs 130, native VMs 140, and/or support VMs 145.

At step 406, a user defines affinity/anti-affinity rules 123. In an embodiment, at step 408, a user can define one or more intra-VM group rules. An intra-VM group rule is an affinity or anti-affinity rule applied against VMs in a VM group 121, For example, an affinity rule can specify that VMs of a VM group 121 be placed in the same host domain. An anti-affinity rule can specify that each VM of a VM group 121 be placed in a different host domain. An intra-VM group rule is an affinity or anti-affinity rule applied between VM groups 121. For example, an affinity rule can specify that two VM groups 121 be placed in the same host domain 119. An anti-affinity rule can specify that two VM groups 121 be placed in two different host domains 119.

At step 412, virtualization management server 116 places VM groups 121 in host domains 119 based on rules 123 for affinity/anti-affinity. In an embodiment, at step 414, virtualization management server 116 places VMs in an anti-affinity VM group across different host domains 119 (e.g., each VM in a VM group 121 in a different host domain 119). For example, VMs in a three member VM group are placed across three host domains 119, one VM per host domain. In an embodiment, at step 416, virtualization management server 116 places VMs in an affinity VM group in the same host domain. The VMs in VM group 121 having intra-VM affinity can be spread evenly across hosts in the specified host domain 119. In an embodiment, at step 418, virtualization management server 116 places a first VM group in a first host domain and a second VM group in a second host domain, where the first VM group is anti-affine with the second VM group based on an anti-affinity rule. In an embodiment, at step 420, virtualization management server 116 places third and fourth VM groups in a third host domain, where the third and fourth VM groups are affine to each other based on an affinity rule.

In an embodiment, a user interacts directly with virtualization management server 116 to place VMs in VM groups 121 in their respective host domains 119 based on rules 123. In another embodiment, a user can interact with supervisor Kubernetes master 104 if supervisor cluster 101 is enabled. In such case, when scheduling pod VMs 130 or native VMs 140 on nodes, supervisor Kubernetes master 104 cooperates with virtualization management server 116 when placing the respective VMs. Scheduler extender 306 can send information for VM groups and affinity/anti-affinity rules defined by the user to virtualization management server 116 during scheduling. Virtualization management server 116 can generate the appropriate VM groups 121 and rules 123 and perform host selection accordingly.

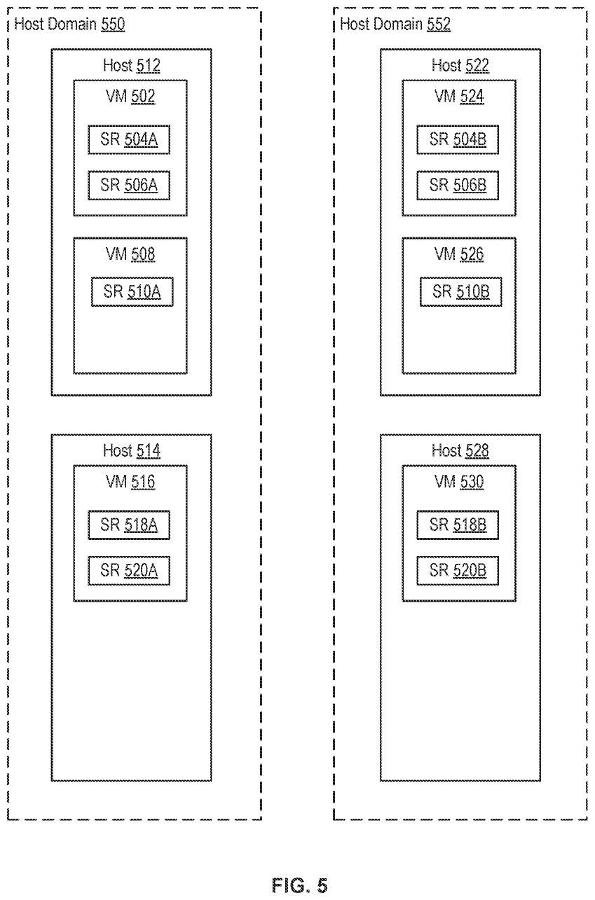

FIG. 5 is a block diagram depicting a placement of VMs in hosts based on affinity/anti-affinity rules according to an embodiment. For purposes of clarity by example, FIG. 5 is described with respect to VMs, VM groups, and host domains, but is applicable to resources, resource groups, and domains more generally. A host domain 550 (e.g., a rack) includes hosts 512 and 514. A host domain 552 another rack) includes hosts 522 and 528. VMs 502, 508, and 516 comprise a first VM group. VMs 524, 526, and 520 comprise a second VM group. VMs 502 and 508 execute in host 512. VM 514 executes in host 514. VMs 524 and 526 execute in host 522. VM 530 executes in host 528. In the example, each VM in the first and second VM groups implements an edge transport node (e.g., edge transport node 178) executing one or more instances of a service router (SR). Each SR is configured in active-standby mode such that there is an active SR instance and a standby SR instance. The edge transport nodes execute five SR instances 504, 506, 510, 518, and 520. The first VM group (VMs 502, 508, and 514) execute active SR instances 504A, 506A, 510A, 518A, and 520A. The second VM group (VMs 524, 526, and 528) execute standby SR instances 504B, 506B, 510B, 518B, and 520B. VM 502 executes SRs 504A and 506A. VM 508 executes SR 510A. VM 516 executes SRs 518A and 520A. VM 524 executes SRs 504B and 506B. VM 526 executes SR 510B. VM 530 executes SRs 51811 and 520B.

In the example of FIG. 5, the first VM group (VMs 502, 508, and 514) comprise an affinity VM group. As such, the VMs 502, 508, and 514 are placed in the same host domain (e.g., host domain 550). Likewise, the second VM group (VMs 524, 526, and 528) comprise an affinity VM group. As such, the VMs 524, 526, and 530 are placed in the same host domain (e.g., host domain 552). The first VM group is anti-affine to the second VM group (e.g., the edge transport node configuration is such that the active SRs are in a separate host domain from the passive SRs). Thus, VMs 502, 508, and 516 are placed in a different host domain from VMs 524, 526, and 530.

One technique for expressing affinity/anti-affinity includes per-VM rules. Thus, a user could assign affinity/anti-affinity rules to each VM separately. However, this results in inefficiency. For example, this requires more rules and can result in placement of VMs across more hosts and/or host domains than necessary. In the techniques described herein, affinity/anti-affinity rules are assigned to VM groups with respect to host domains (host groups). This requires less rules and results in increased efficiency. VMs are placed across less hosts and/or host domains while still meeting the required design constraints (e.g., active SR instances in a separate fault domain, e.g., rack, from standby SR instances).

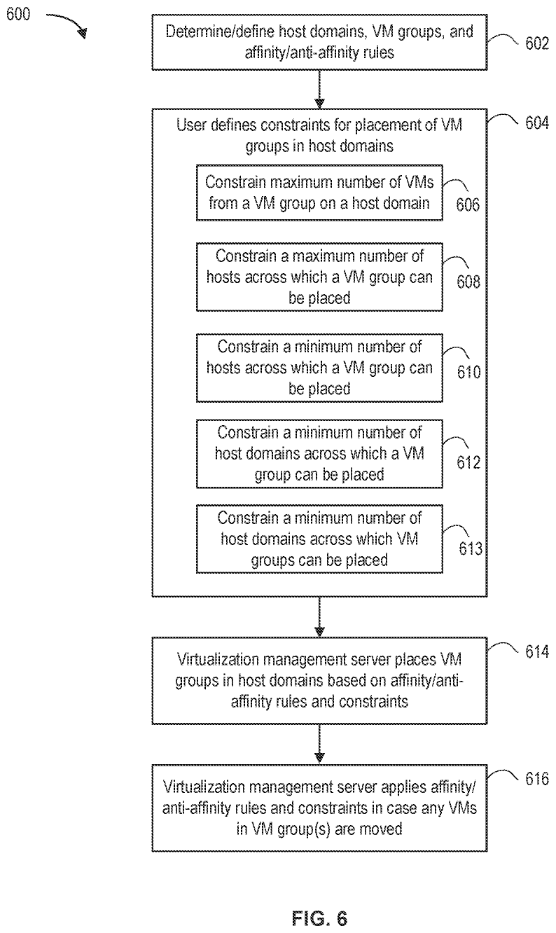

FIG. 6 is a flow diagram depicting a method 600 of placing VMs in host cluster 118 based on affinity/anti-affinity to host domains and constraints according to an embodiment. For purposes of clarity by example, method 600 is described with respect to VMs, VM groups, and host domains, but is applicable to resources, resource groups, and domains more generally. Method 600 begins at step 602, where virtualization management server 116 determines host domains 119 and VM groups 121, and a user defines rules 123 for affinity/anti-affinity. In an embodiment, the user interacts with virtualization management server 116 to define host domains 119, VM groups 121, and rules 123 for affinity/anti-affinity as discussed above.

At step 604, the user defines constraints for placement of VM groups in host domains. Constraints 136 can be stored in database 117 (FIG. 1). In an embodiment, at step 606, the user constrains the maximum number of VMs from a VM group 121 on a host domain 119, For example, a VM group may be subject to licensing requirements, such as only a threshold number of VMs can be running concurrently. Such a constraint would ensure that no more than the threshold number of VMs in a VM group are placed in a host domain concurrently in order to satisfy such a licensing requirement.

In an embodiment, at step 608, the user constrains a maximum number of hosts across which a VM group can be placed. For example, a user may have five licenses that can be assigned to any host in the cluster. Whichever five hosts virtualization management server 116 selects, the VMs that use this license can only run on those hosts. A host domain can have more than five hosts, but with such a constraint, the VMs in the VM group are only placed on five hosts in the host domain in order to satisfy the license. It is to be understood that the case of five licenses is an example and that any number of licenses can be used.

In an embodiment, at step 610, the user constrains a minimum number of hosts across which a VM group can be placed. For example, a user can desire that a group of three VMs can always handle a host failure. This means that the three VMs need to run on at least two different hosts. Such a constraint is useful when considering how many hosts to upgrade concurrently, if too many hosts are upgraded concurrently, then that would force these VMs to be moved and co-located on a smaller set of hosts. This constraint dictates to virtualization management server 116 what the smallest number of hosts is on which these VMs can be co-located while still meeting the user's availability goals. It is to be understood that the case of three VMs is an example and that any number of VMs can be so constrained.

In an embodiment, at step 612, the user constrains a minimum number of host domains across which a VM group can be placed. This constraint is similar to the constraint in step 610, but now the user wants to be able to tolerate host domain failures (e.g., rack failures). This constraint sets a bound on the number of host domains (e.g., racks) that can be upgraded concurrently, for example.

In an embodiment, at step 613, the user constrains a minimum number of host domains across which VM groups can be placed. This constraint is similar to that in step 612, but now the user applies a constraint not to a number of VMs in a VM group, but rather to a number of VM groups. For example, each VM group can be a Kubernetes cluster that executes a set of microservices.

At step 614, virtualization management server 116 places VM groups 121 in host domains 119 based on rules 123 for affinity/anti-affinity and constraints. At step 616, virtualization management server 116 applies rules 123 for affinity/anti-affinity and the constraints during migration of VMs in VM group(s) (e.g., due to host/host domain failures).

In an embodiment, priority/weights can be added to rules 131. For example, VMs can be part of different affinity/anti-affinity relations and the scheduler satisfies the rules in priority order or minimizes the cost of the violations by considering the weights. In an embodiment, priority/weights can be added to constraints 136. For example, when can an affinity/anti-affinity rule be fixed at the cost of a constraint on max/min number of VMs/hosts. Similarly for other constraints that determine the conditions under which the affinity/anti-affinity rule can be violated. For example, it could be that the maintenance-mode operation that evacuates the VMs to allow upgrade of the hypervisor is a valid reason to violate the rule or it could not be, or cpu/memory utilization can be a valid reason to violate a rule or not. As there are minimum hosts/host-domains in relation to an anti-affinity rule, there can be maximum host/host groups with an affinity rule. In particular, with the above reasons to introduce violations, there could be one set of reasons that is valid to introduce violations of an affinity/anti-affinity rule. Out of that set of reasons there will be only a small subset (or none) of reasons that is valid to violate that minimum or maximum number of host/host domains.

The embodiments described herein may employ various computer-implemented operations involving data stored in computer systems. For example, these operations may require physical manipulation of physical quantities. Usually, though not necessarily, these quantities may take the form of electrical or magnetic signals, where the quantities or representations of the quantities can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of placing resources in domains in a virtualized computing system having a host cluster, the host cluster having a virtualization layer executing on hardware platforms of the hosts, the method comprising:
determining, at a virtualization management server, definitions of the domains and of resource groups, each of the domains including a plurality of placement targets, each of the resource groups including a plurality of the resources;
receiving, at the virtualization management server from a user, affinity/anti-affinity rules that control placement of the resource groups within the domains; and
placing, by the virtualization management server, the resource groups within the domains based on the affinity/anti-affinity rules.

2. The method of claim 1, wherein the affinity/anti-affinity rules include a rule specified for resources within a first resource group of the resource groups.

3. The method of claim 1, wherein the affinity/anti-affinity rules include a rule specified for first and second resource groups of the resource groups.

4. The method of claim 1, wherein the affinity/anti-affinity rules include a first anti-affinity rule for resources of a first resource group, and wherein the virtualization management server places the resources of the first resource group across different domains of a first domain based on the first anti-affinity rule.

5. The method of claim 1, wherein the affinity/anti-affinity rules include a first affinity rule for resources of a first resource group, and wherein the virtualization management server places the resources of the first resource group within a same domain of the domains based on the first affinity rule.

6. The method of claim 1, wherein the affinity/anti-affinity rules include a first affinity rule for first and second resource groups of the resource groups, and wherein the virtualization management server places each of the first and second resource groups in a same domain of the domains.

7. The method of claim 1, wherein the affinity/anti-affinity rules include a first anti-affinity rule for first and second resource groups of the resource groups, and wherein the virtualization management server places the first resource group in a first domain of the domains, and the second resource group in a second domain of the domains, based on the first anti-affinity rule.

8. The method of claim 1, wherein the resource groups are virtual machine (VM) groups and the domains are host domains, each of the host domains including a plurality of the hosts as the plurality of placement targets, each of the VM groups including a plurality of VMs managed by the virtualization layer.

9. The method of claim 1, wherein the resource groups are disk groups and the domains are datastore domains, each of the datastore domains including a plurality of datastores managed by the virtualization management server as the plurality of placement targets, each of the disk groups including as plurality of virtual disks.

10. A non-transitory computer readable medium comprising instructions to be executed in a computing device to cause the computing device to carry out a method of placing resources in domains in a virtualized computing system having a host cluster, the host cluster having a virtualization layer executing on hardware platforms of the hosts, the method comprising:
determining, at a virtualization management server, definitions of the domains and of resource groups, each of the domains including a plurality of placement targets, each of the resource groups including a plurality of the resources;
receiving, at the virtualization management server from the user, affinity/anti-affinity rules that control placement of the resource groups within the domains; and
placing, by the virtualization management server, the resource groups within the domains based on the affinity/anti-affinity rules.

11. The non-transitory computer readable medium of claim 10, wherein the affinity/anti-affinity rules include a rule specified for resources within a first resource group of the resource groups.

12. The non-transitory computer readable medium of claim 10, wherein the affinity/anti-affinity rules include a rule specified for first and second resource groups of the resource groups.

13. The non-transitory computer readable medium of claim 10, wherein the affinity/anti-affinity rules include a first anti-affinity rule for resources of a first resource group, and wherein the virtualization management server places the resources of the first resource group across different domains of a first domain based on the first anti-affinity rule.

14. The non-transitory computer readable medium of claim 10, wherein the affinity/anti-affinity rules include a first affinity rule for resources of a first resource group, and wherein the virtualization management server places the resources of the first resource group within a same domain of the domains based on the first affinity rule.

15. The non-transitory computer readable medium of claim 10, wherein the affinity/anti-affinity rules include a first affinity rule for first and second resource groups of the resource groups, and wherein the virtualization management server places each of the first and second resource groups in a same domain of the domains.

16. The non-transitory computer readable medium of claim 10, wherein the affinity/anti-affinity rules include a first anti-affinity rule for first and second resource groups of the resource groups, and wherein the virtualization management server places the first resource group in a first domain of the domains, and the second resource group in a second domain of the domains, based on the first anti-affinity rule.

17. A virtualized computing system, comprising:
a host cluster and a virtualization management server each connected to a physical network;
the host cluster including hosts and a virtualization layer executing on hardware platforms of the hosts;
wherein the virtualization management server is configured to place resources in domains by:
determining definitions of the domains and resource groups, each of the domains including a plurality of placement targets, each of the resource groups including a plurality of the resources;
receiving, from the user, affinity/anti-affinity rules that control placement of the resource groups within the domains; and
placing the resource groups within the domains based on the affinity/anti-affinity rules.

18. The virtualized computing system of claim 17, wherein the resource groups are virtual machine (VM) groups and the domains are host domains, each of the host domains including a plurality of the hosts as the plurality of placement targets, each of the VM groups including a plurality of VMs managed by the virtualization layer.

19. The virtualized computing system of claim 17, wherein the resource groups are disk groups and the domains are datastore domains, each of the datastore domains including a plurality of datastores managed by the virtualization management server as the plurality of placement targets, each of the disk groups including as plurality of virtual disks.

20. The virtualized computing system of claim 17, wherein the affinity/anti-affinity rules include a first anti-affinity rule for first and second VM groups of the VM groups, and wherein the virtualization management server places the first VM group in a first host domain of the host domains, and the second VM group in a second host domain of the host domains, based on the first anti-affinity rule.
